(19) United States
(12) Patent Application Publication
(10) Pub. No.: US 2024/0078189 A1
(43) Pub. Date: Mar. 7, 2024

(54) MULTI-TENANT DISTRIBUTED CACHE ARCHITECTURE FOR OBJECT ACCESS AND EXPIRATION AND SYSTEMS AND METHODS FOR CUSTOMIZED COMPUTER VISION-ORIENTED CONVOLUTIONAL NEURAL NETWORKS

(71) Applicant: META PLATFORMS, INC., Menlo Park, CA (US)

(72) Inventors: Stuart Clark, San Ramon, CA (US); Hong Lu, Redwood City, CA (US); Eden Zik, Brooklyn, NY (US)

(21) Appl. No.: 18/461,159

(22) Filed: Sep. 5, 2023

Related U.S. Application Data
(60) Provisional application No. 63/374,852, filed on Sep. 7, 2022.

(51) Int. Cl. G06F 12/121; G06F 12/0806; G06N 3/0464

(52) U.S. Cl. CPC G06F 12/121; G06F 12/0806; G06N 3/0464

(57) ABSTRACT

The present disclosure provides systems, methods, devices, and computer program products for cache eviction enforcement and multi-tenant distributed cache architectures and operations. Systems, methods, devices, and computer program products may access a slab of a multi-tenant caching system, perform an eviction review by sequentially reaping through the slab, based on the class size, flag a first cache item by the eviction review based on a header of the first cache item, wherein the header comprises a prefix indicative of an expiry time, confirm expiration of the first cache item via a lock and lookup operation, and evict the first cache item from the slab. Significant optimization and efficiency benefits may be realized through the slab organization, cache architectures, and operations discussed herein.

The present application also provides systems, methods, devices, and computer program products for convolutional neural networks (CNN) applicable for image processing and computer vision-oriented operations. The CNN system may include dedicated blocks, for specific image processing operations, to significantly improve efficiency and reduce bandwidth and computational costs. CNN systems and methods, as discussed herein, may include a pre-processing module to at least convert initial image data to a first format, a CNN core to process image data according to convolution parameters and generate processed image data, a post-processing module to convert the processed image data to output packets, and a control module to manage communications and operations between various modules.

### CROSS-REFERENCE TO RELATED APPLICATIONS

This application claims the benefit of U.S. Provisional Patent Application No. 63/374,852, filed Sep. 7, 2022, entitled “Memcache Time To Access Lifetime Optimization,” the entire content of which is incorporated herein by reference.

### TECHNICAL FIELD

Exemplary embodiments of this disclosure relate generally to methods, apparatuses, and computer program products for eviction cache enforcement and multi-tenant distributed cache architectures. Additionally, the present application generally is directed to systems and methods for block-based convolutional neural networks (CNNs).

### BACKGROUND

Cache hosts enable the storage of data items for efficient access and retrieval. Traditional caching approaches often have a certain lifetime, or retention period, after which the cache item gets evicted. However, cache hosts can contain billions of items with unique access patterns or different backgrounds. Therefore, applying a one-size-fits-all approach to retention is neither efficient nor ideal. Accordingly, building improved caching solutions, such as allowing items to be cached for an optimal amount of time without impacting packet processing performance or fragmenting memory resources may be needed.

### BRIEF SUMMARY

Various embodiments are described for eviction cache enforcement and multi-tenant distributed cache architectures. Systems, methods, and devices, may include accessing a slab of a multi-tenant caching system, wherein the slab is defined by a memory size and a class size, the class size corresponding to a size of cache items stored within the slab, performing an eviction review by sequentially reaping through the slab, based on the class size, flagging a first cache item by the eviction review based on a header of the first cache item, wherein the header comprises a prefix indicative of an expiry time, confirming expiration of the first cache item via a lock and lookup operation, and evicting the first cache item from the slab.

In various examples an initial expiry time may be associated with the first cache item. An expiry time may refer to a time after which a cache item will be evicted. In various examples, determining the expiry time may include determining an initial expiry time associated with the first cache item, and updating the expiry time. The expiry time may be updated to a time to a time to access when the initial expiry time is greater than the time to access. In another example, the expiry time may be updated to a sum of a current time and a time to access, when the sum of a current time and a time to access is less than the expiry time.

In some examples the expiry time is a Time to Live (TTL) associated with the first cache item. The expiry time may also be based on at least one of a historical access of the first cache item, the time to live (TTL) associated with the first cache item, or a machine learning model trained on access times of other cache items. The class size of the slab may define a byte size of cache items stored within the slab. The slab may also include a memory size indicative of a storage capacity of the slab.

In some examples, when the expiry time associated with the second cache item is greater than the time to access, the expiry time associated with the second cache item may be updated to the time to access. In another example, when the sum of the current time and the retention time is less than the initial expiry time, the expiry time associated with the second cache item may be updated to a sum of a current time and the time to access.

The eviction review may be performed by sequentially iterating through the slab based on the class size. The eviction review may also iterate through headers associated with the cache items stored within the slab. In other examples, the reaper may evict the first cache item from the slab when the eviction review determines that the expiry time has been exceeded or is less than a current time. In some examples, the reaper evicts the first cache item by at least: locking the slab, identifying a location of the first cache item by performing a lookup using a hash table and key, and removing the first cache item.

One aspect of the application at least describes block-based CNN systems, methods, and devices. Various aspects may enable image scaling, such as up-scaling, down-scaling, frame rate conversions, and the like. Another aspect of the application at least describes an apparatus including a non-transitory memory including stored instructions for implementing the various methods discussed herein. The apparatus may also include a processor operably coupled to the non-transitory memory that is configured to execute the stored instructions.

An example system may include a pre-processing module, a convolutional neural network, a post-processing module, and a control module. The pre-processing module may receive initial image data and convert the initial image data to a first format. The CNN may receive the initial image data in the first format from the pre-processing module and convolution parameters from the pre-loaded or dedicated buffer. In some examples, the convolutional neural network processes the initial image data according to the convolution parameters to generate an output layer comprising processed image data, which may be scaled image data. The post-processing module may convert the processed image data to output packets, which may be provided to an external memory. The control module may manage communications between the pre-processing module, the convolutional neural network, the circular buffer, and the post-processing module.

In some examples, the pre-processing module may convert the initial image data to the first format by performing a color space conversion to convert image data from a first color space to a second color space. In some examples, the first color space is RGB, YUV, HSL, or CMYK, and the second color space is a different color space.

The pre-processing module may convert the initial image data to the first format by performing chroma up-sampling or down-sampling. According to some examples, the first format is RGB.

The convolutional neural network may further include a Rectified Linear Unit (ReLU) circuit to produce the output layer. In various examples, a ReLU activation function may be defined as f(x)=max(0, x), and include several layers to compute a weighted sum of inputs, which may be applied to the activation function, and subsequently used as inputs in a next layer. In some examples, the ReLU circuit may receive ReLU parameters from a buffer in the CNN. During processing operations, the CNN may run a plurality of iterations and produce a plurality of layers before the output layer. In some examples, the CNN further comprises a mux unit to combine the initial image data and the convolution parameters. The convolution parameters may include kernel parameters associated with a scaling operation, such as up-scaling, down-scaling, frame rate conversions, noise reductions, and the like. The CNN may further receive, via the mux unit, kernel parameters from a kernel buffer.

The post-processing module may apply at least one of a color space conversion, up-scaling, or down-scaling. The color space conversion may be based on parameters defined by an external memory. In examples, the post-processing module transfers the output packets to at least one external memory.

The processed image data may also be indicative of a frame rate conversion from the initial image data. For example, the initial image data may be indicative of a first frame rate, and the processed image data is indicative of a second frame rate. In some examples, the first frame rate is less than the second frame rate.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates cache operations on a backed according to various examples discussed herein.

FIG. 2 illustrates a cache retention policy according to various examples discussed herein.

FIG. 3 illustrates a cache reaping operation according to various examples discussed herein.

FIG. 4 another cache reaping operation according to various examples discussed herein.

FIG. 5A illustrates a Time to Access implementation on a Set Request according to various examples discussed herein.

FIG. 5B illustrates a Time to Access implementation on a Get Request according to various examples discussed herein.

FIG. 6 illustrates a cache eviction enforcement operation according to various examples discussed herein.

FIG. 7 is a diagram of an exemplary computer system according to various examples discussed herein.

FIG. 8 shows a block diagram of a distributed computer system, in which various aspects may be implemented, according to various examples discussed herein.

FIG. 9 illustrates a block diagram of an example computing system according to various examples discussed herein.

FIG. 10A illustrates a communication system in accordance with the present application.

FIG. 10B illustrates a machine learning architecture in accordance with the present application.

FIG. 11 illustrates an example node in accordance with the present application.

FIG. 12 illustrates a block diagram of an example computing system in accordance with the present application.

FIG. 13 illustrate an example flowchart in accordance with the present application.

FIG. 14 illustrates an example embodiment of the present application.

FIG. 15 illustrates an example pre-processing module in accordance with the present application.

FIG. 16 illustrates in an example CNN core in accordance with the present application.

FIG. 17 illustrates an example post-processing module in accordance with the present application.

FIG. 18 illustrates an example control module in accordance with the present application.

The figures depict various examples for purposes of illustration only. One skilled in the art will readily recognize from the following discussion that alternative aspects and examples of the structures and methods illustrated herein may be employed without departing from the principles described herein.

### DETAILED DESCRIPTION

The present disclosure can be understood more readily by reference to the following detailed description taken in connection with the accompanying figures and examples, which form a part of this disclosure. Some examples will be described with reference to the accompanying drawings, in which some, but not all examples of the invention are shown. Indeed, various examples of the invention may be embodied in many different forms and should not be construed as limited to the embodiments set forth herein.

As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal. In addition, like reference numerals refer to like elements throughout.

References in this description to “an embodiment”, “one embodiment”, “an example,” “one example” or the like, may mean that the particular feature, function, aspect or characteristic being described is included in at least one embodiment or example of the present invention. Occurrences of such phrases in this specification do not necessarily all refer to the same embodiment or example, nor are they necessarily mutually exclusive.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment.

It is to be understood that the methods and systems described herein are not limited to specific methods, specific components, or to particular implementations. The terminology used herein is for the purpose of describing particular embodiments only and is not intended to be limiting. Certain features of the disclosed subject matter which are, for clarity, described herein in the context of separate embodiments, can also be provided in combination in a single embodiment. Conversely, various features of the disclosed subject matter that are, for brevity, described in the context of a single example, can also be provided separately or in any sub-combination. Further, any reference to values stated in ranges includes each and every value within that range.

### A. Multi-Tenant Distributed Cache Architecture

Systems, methods, and devices provide cache solutions enabling to-the-second retention control for cache items, without fragmenting cache memory resources. Systems, methods, and devices utilize a highly efficient cache iterator (also referred to herein as “the reaper” or “reaping”) which may iterate the cache in a few seconds to control lifetime without impacting cache performance. The lifetime of individual objects may be managed by a lightweight data structure that may make items to configured lifetimes without impacting performance.

Traditional techniques to provide different cache retentions often involve physically partitioning resources, but this is inefficient due to fragmentation, and suboptimal from a use-case perspective when the retention offered by the cache may not exactly match the ideal retention of the use-case. Various examples discussed herein enable a theoretical target retention of all use-cases to be enforced with almost zero cost.

Various systems, methods, and devices discussed herein may be implemented in MEMCACHE. Compared to traditional methods, the approaches presented herein currently saves around 50% of the MEMCACHE fleet with respect to hardware cost.

Systems and methods are disclosed for operating a cache in a multi-tenant system. Multi-tenant systems may include multiple users and customers with various caching requirements and/or cost models. Some examples may include a cloud provider managing multiple tenants and providing an enforcement mechanism utilizing Time to Access (TTA) to manage cache data. TTA determinations may use various metrics and requirements, which may be defined or determined using one or more machine learning and/or heuristic models to determine an estimated lifetime for a cache item. Thus, TTA may protect other use cases in a multi-tenant tier during sudden changes in workload and have no measurable impact on packet processing performance.

Such techniques and implementations eliminate fragmentation of memory resources, which is common in traditional caching architectures. Seamless colocation of a plurality of use cases (e.g., tens of thousands or more) and coexistence of billions of items on a host may be realized, with discreet retention times managed by TTA.

Various examples improve upon reaping operations and enable scanning through cache data, then applying enforcement techniques to identify and remove expired or invalid cache items. Techniques may be applied on a multi-tenant system, and distributed caches. For example, systems, methods, and devices may be applied to caches hosted on a plurality of data centers, which may be in multiple locations.

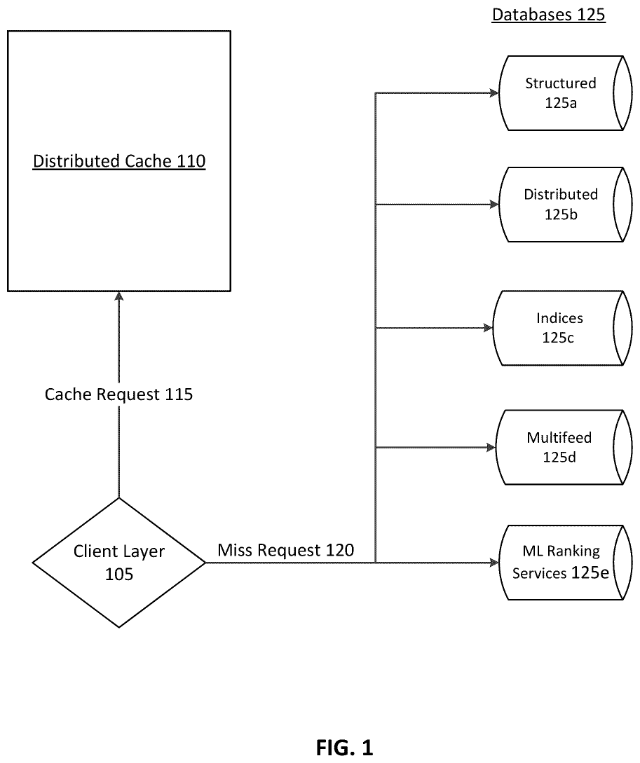

FIG. 1 illustrates cache operations 100 on a heterogenous backend. A client layer 105 may initiate a cache event, in which the client, or for example, an application of the client makes a request to receive a data item. The cache event includes a cache request 115, and may access a distributed cache system 110, such as MEMCACHE. If the requested data item is a cache item located within the distributed cache 110, then the data item may be accessed.

If the data item is not located within the distributed cache system, e.g., when the data item is not in cache memory, then the request is considered a “Miss Request” 120 or “Cache Miss”. A Miss Request 125 may occur if the data item was never stored or located within the distributed cache system 110, is not accessible, corrupted, or has been removed from the cache. As discussed herein, data items may be removed from cache, for example, when a retention time expires (e.g., the data item has not been accessed for a period of time).

As such, when a Miss Request 120 occurs, the data item may be retrieved from another location, such as a database 125. There may be one or more databases from which the data item may be searched for and retrieved. Such databases may include structured databases 125a, distributed databases 125b, indices for databases 125c, Multifeed 125d, or Machine Learning Ranking Services 125e. Typically, when data items are retrieved from a database 125 as a result of a Miss Request 120, increased latency exists. In other words, requests may be completed faster when the data item is accessed via a cache system (e.g., distributed cache 110) as the data item is more readily available. The Miss Request 120 occurs after the Cache Request 115, and therefore results in a longer time period for the data item request to be completed. Since cache systems (e.g., distributed cache system 110), contain large volumes of data, and may have limited memory capacities, it is beneficial to apply cache policies that identify commonly used data items and data items likely to be accessed, while eliminating data items that are rarely accessible and/or unlikely to be accessed. Such operations assist in providing improved and timely access to data items and providing an efficient memory space.

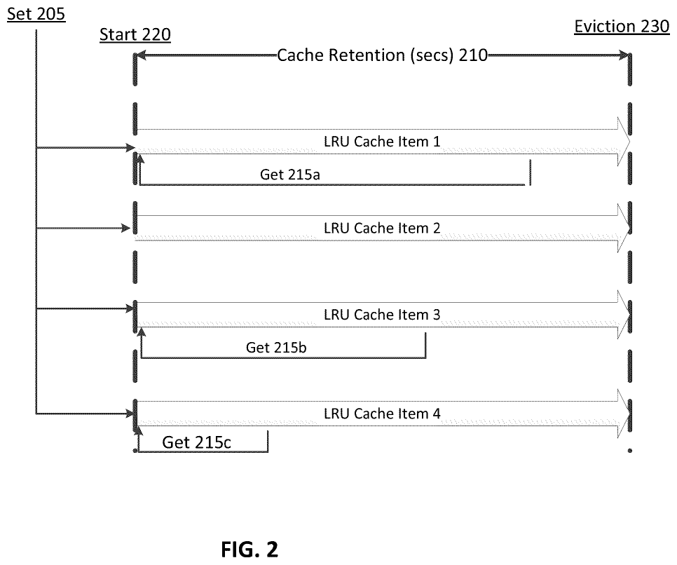

FIG. 2 illustrates a Least Recently Used (LRU) cache retention policy, aspects of which may be utilized in various examples discussed herein. In an LRU retention policy 200, items within a cache may be assigned a cache retention 210. The cache retention may be a lifetime of a number of seconds, as in the example of FIG. 2, but may also be shorter or longer, such as minutes, hours, days, etc. A plurality of cache items, e.g., data items, may exist within the cache. LRU Cache Item 1, LRU Cache Item 2, . . . , LRU Cache Item N, are examples of cache items existing within a cache. In some examples, hundred, millions, or even billions of items may exist in a cache.

An LRU policy may evict a cache item after the cache retention lifetime expires for the cache item. As illustrated in FIG. 2, a “set” action may be a set request 205 for a cache item. A set request may refer to setting and/or writing data to a cache memory. The “get” actions, 215a-c, may refer to a get request in which cache item being called on. When such an action occurs, the cache retention clock is reset to start time 220. If the item is not called on within the cache retention lifetime 210, an eviction action 230 may occur and the cache item is deleted from the cache. Accordingly, when the cache retention 210 is reached, this may be indicative that the cache item has not been used for a period of time, and therefore, should be evicted to free up space. Thus, the implemented LRU policy defines and determines which items are evicted from the cache.

With respect to infrastructure, cache essentially shields back ends from queries per second (QPS). Thus, cache content can have a significant effect on speed, latency, and access of data items, and optimization and improvement of cache content thereby may affect QPS and speed.

A challenge with a standardized cache retention which assigns a set cache retention for all items, is that cache items often have different requirements and characteristics in terms of how much caching they need, how often they are accessed, etc. As such, this presents quite a difficult multi-tenancy problem, and determining how to account for different lifetimes or different characteristics for different use cases. For example, an ideal retention time for one cache data item may be one minute, while another cache item may have an ideal retention time of ten minutes. If a cache data item has not been accessed within its respective retention time, it may be evicted.

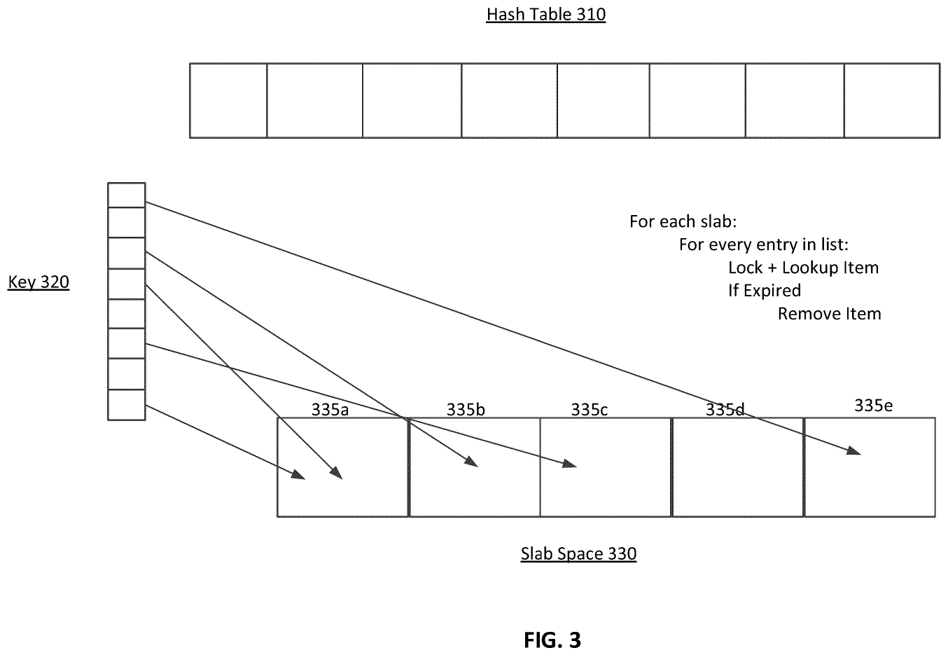

FIG. 3 illustrates a traditional expiration determination and eviction technique utilizing a hash table, a key, and a slab allocation. The slab allocation may contain cache data items and assist in efficient memory allocation. In various examples, cache items may be stored based on size. In one reaper implementation, a cache may be indexed by a hash table 310. In some examples, the hash table may contain a plurality of entries, e.g., 2³⁰ entries. A key 320 assists in performing lookups, by identifying where a data item is located in the slab space 330. As discussed herein, data items may be associated with an LRU indicative of a retention lifetime. A reaper may iterate through the cache to identify cache items and determine whether the cache item has expired based on the LRU determination. If the cache item has exceeded its LRU limit, it may be evicted (e.g., deleted from cache), and if not, then the cache items may remain in the slab space.

The slab space 330 may contain a plurality of buckets 335a-e within which cache items may be stored. There is not necessarily a relationship between the organization of hash table to where the cache items are stored in the slab space. Thus, reaping operations may be very computationally expensive. For example, verifying a cache item may require a couple locks and data logs. Once a cache item's location is identified within the slab space 330 via the key 320, a lock may be placed on the slab (e.g., bucket 335a, if the cache item is identified to be within that bucket), and then a lock on the cache item within that slab. Accordingly, this reaper design's efficiency may be considered based on a number of items in a cache, multiplied by the cost of the lock for each item. Cache misses may also be taken into account, and also adds to the computational load and operations.

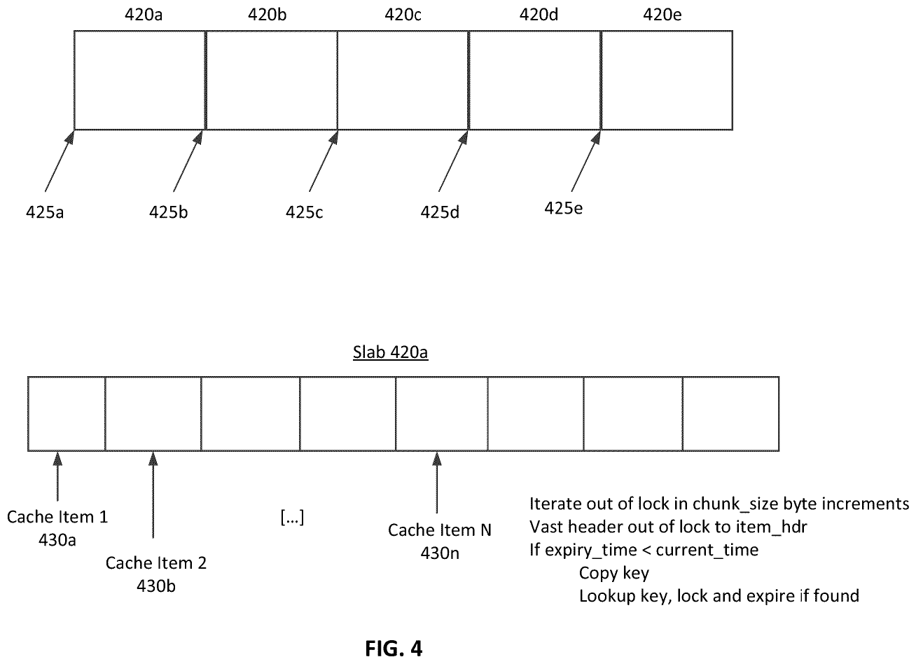

FIG. 4 provides an improved reaper design 400 to significantly reduce computational load and operational time and increase overall efficiency. Rather than utilizing a hash table and locking a particular slab and cache item within the slab space, the reaper design of FIG. 4 eliminates those operations and goes directly to the memory space, e.g., the slab space. Slabs may be organized into classes based on a memory size of objects stored within the slab. For example, in FIG. 4, slab 420a (illustrated as part of slab space 410, and a close up comprising Cache Item 1 to Cache Item N) may have a class size of 64 bytes, wherein objects within the slab (e.g., Cache Item 1 430a, Cache Item 2 430b, . . . , Cache Item N 430n) are 64 bytes or less. Similarly, slab 420b may have a class size of 128 bytes, 420c may have a class size of 254 bytes, slab 420d may have a class size of 512 bytes, and slab 420e may have a class size of 1024 bytes, each with objects less than or equal to its respective class size. In various examples, the class size of a particular slab may be identified in the slab's header, i.e., headers 425a-e. It should be appreciated that class sizes of slabs may be defined as any of a plurality of memory sizes, and need not be limited to the class sizes presented in the example of FIG. 4

Slabs may also have an associated memory size. For example, slabs 420a-e may have a memory size of 4 MB. However, slabs may have other memory sizes in accordance with examples discussed herein.

For a given slab 420a-e, based the memory size and class size, slab objects (e.g., cache items) may be reviewed. In the example of slab 420a, with a memory size of 4 MB and a class size of 64 bytes, an iteration can occur based on the class size, to walk through and review items every 64 bytes, all the way through the memory size of 4 MB. Cache items may be reviewed through this method of sequentially walking through the memory.

In various examples, reaping instructions may include the following: (i) iterating out of lock in class size (e.g., byte) increments; (ii) casting a header out of lock to the item header; (iii) if the expiration time is less than a current time, then copy the key, lookup the key, lock to the object, and expire if needed; and (iv) continue iterating.

From a processing standpoint, this eliminates the need for a lookup via a hash table and key for each item, and the additional, unnecessary locks that occur through that process. Instead, an item header may be cast to determine whether the cache item looks like a valid item that might have expired. If yes, then the key may be copied, and the normal process of a lookup (e.g., via the process discussed in FIG. 3) may occur. If the item does not appear to be expired, then the next item may be reviewed, e.g., at the next class size increment.

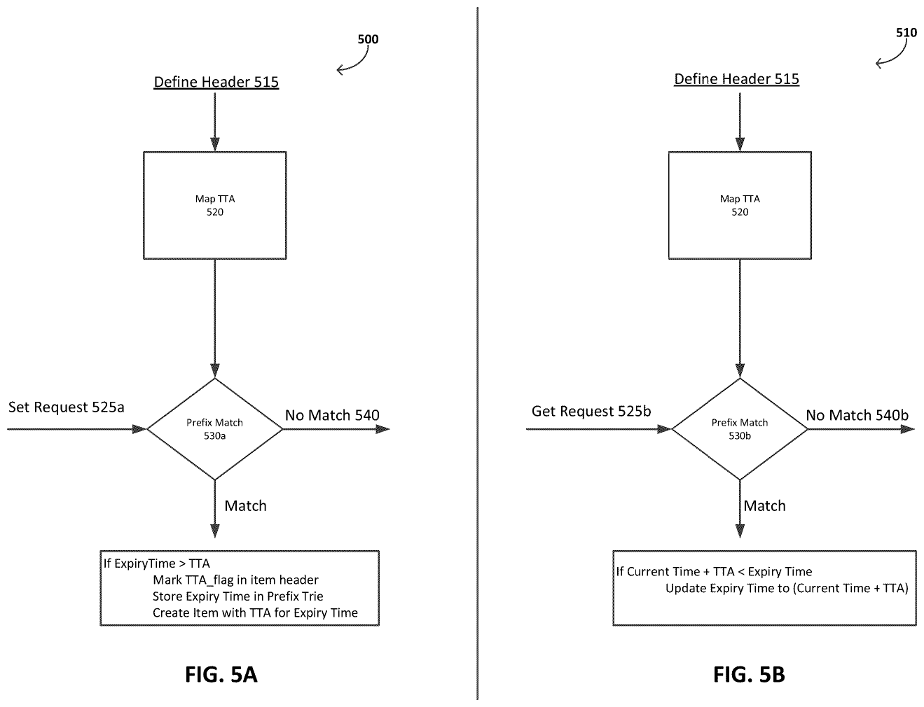

This reaping process significantly reduces the number of locks and lookups that occur when determining whether cache items have expired and should be evicted. The number of locks taken on cache items is significantly reduced since an object's header number can indicate whether an object may be expired or not (see, e.g., FIG. 5, TTA, etc.), and the lock is taken when the object's header is indicative of the object possibly being expired. As discussed herein, for example, with respect to TTA techniques, headers may be defined to be indicative of an expiration, and thereby provide information on whether an object might be expired, and if so, to be reviewed. Thus, the efficient organization of slabs and objects stored in slabs based on size, locations of cache items may be easily iterated, and based on the header, a quick determination may be made with respect to expiration. As such, rather than walking through a hash table, to find, lock, and review every item within a slab space—a very computationally expensive task—an organized slab space may be efficiently reviewed via an iteration through each slab based on its class size, and a review of object headers to determine whether to lookup, lock, and expire a particular object/cache item.

In other words, during the improved reaping operations, slabs may be sequentially iterated through without locks and without cache misses. Rather, the reaper design optimistically assumes the item is valid and checks the expiration timestamp. When items are optimistically labeled as expired, traditional expiration operations may occur. As a whole, reaping in this process significantly reduces the number of locks that occur, thus making cache expiration operations more computationally efficient and significantly faster than traditional caching techniques.

Sequentially iterating through memory is more CPU cacheline friendly, as the processor may prefetch objects. The number of locks taken is approximately on the order of the number of expired items. This is because locks are only taken if an object appears to be expired, e.g., based on the object header.

Contrasting the speed and efficiency of these methods, in the reaper design of FIG. 3, for a given number of cache items (e.g., 500 million to 1 billion cache items), a given number of item expirations per second (e.g., 50,000 items per second), and zero locks and cache misses, an iteration will be on the order of the time it takes to review, identify and eliminate each expired item. For the numbers in the above example, this would take between 20-60 minutes. By comparison, using the reaper design discussed in FIG. 4, given the same number of cache items (e.g., 500 million to 1 billion cache items), and number of item expirations per second (e.g., 50,000 items per second), also with zero locks and cache misses, an iteration may take only 3 seconds. Thus, significant improvements may be realized in terms of efficiency, latency, and computational load.

### Time to Access (TTA)

FIGS. 5A and 5B illustrate Time to Access (TTA) implementations, usable with various examples discussed herein, such as with the reaping operations discussed above. FIG. 5A describes a Set Request implementation, and FIG. 5B describes a Get Request implementation.

In distributed caching systems, such as MEMCACHE, there exists an efficiency optimization known as Time to Access (TTA), which aims to optimize memory footprint.

TTA may be applied to use cases which:
Have a high memory footprint in MEMCACHE.
Have a heavy read bias towards the time that objects are written.
Have a high percentage of objects that are evicted/expired and have never been read.
Have an ideal retention beyond which hit rate is shown not to improve, per working set analysis.

A high percentage of memory in distributed caching systems may be consumed by a low percentage of the keys in a key space. Such keys often have sub-optimal retention in caches. Accordingly, systems, methods, and devices implementing TTA provide an infrastructure to allow control of the retention of specific key prefixes.

Moreover, in some implementations, more than 50% of memory in the Memcache fleet and/or the system may be dominated by a few use cases with large items. The Time To Access feature permits a soft Time to Live (TTL) to be configured on a per prefix basis. If the item is not accessed before the soft TTL expires, the item may be removed from cache.

In various embodiments, TTA may be implemented in Dynamic Random Access Memory (DRAM) and/or flash memory. Use cases may be assigned a single TTA value, however more complex offline analyses, including object size and other variables, may be utilized.

FIGS. 5A and 5B illustrate this concept. TTA may be derived based on a historical access pattern and other heuristics to determine an ideal amount of time an object should remain in the cache. Based on this amount of time and an enforcement mechanism (e.g., the reaper mechanisms discussed above), an object will remain in cache during its given lifetime, and be evicted upon its expiration, thus optimizing space and memory for the cache.

In the Set Request example from FIG. 5A, at block 515, an object's TTA may be defined. As discussed herein, the TTA may be determined based on historical access, heuristics, and any of a plurality of determination methods. At block 520, the TTA may be mapped, or otherwise associated with, the prefix/header associated with the object. A prefix match analysis 530a may occur upon receipt of a Set Request 525a. If there is no prefix match 540, no action is taken with regard to the object.

If there is a prefix match 550, the TTA may replace the object's expiry time when the expiry time is greater than TTA. In some examples, when a prefix match is identified, the following procedure may be implemented:
If expiry time>TTA
   Mark TTA_flag in item header;
   Store expiry time in prefix trie;
   Create item with TTA for expiry time.

Turning to FIG. 5B, with respect to a Get Request, a TTA may first be defined (block 515) based on any of the methods discussed above. Similar to FIG. 5A, at block 520, the TTA may be mapped, or otherwise associated with, the prefix/header associated with the object. A prefix match analysis 530b may occur upon receipt of a Get Request 525b. If there is no prefix match 545, no action is taken with regard to the object.

If there is a prefix match 560, the current time+TTA may replace the object's expiry time when the current time (i.e., time since last access)+TTA is less than the expiry time. In some examples, when a prefix match is identified, the following procedure may be implemented:
If Current Time+TTA<Expiry Time:
   Update Expiry Time to Current Time+TTA

In one example, an object may be stored to cache with a Time to Live (TTL) of 30 minutes. The 30-minute TTL time may be an upper bound, wherein the object is given a 30 minute time window to live and will be expired after that time, regardless of how often it's being read (e.g., every second, minute, etc.). The optimal retention time (e.g., TTA) may actually be one minute, and may be determined through various historical access patterns, heuristics, machine learning mechanisms, and the like. Based on this information, the TTA implementation will store the 30-minute TTL limit in a data structure, and provide a one minute expiration time. Each time the object is read, the expiration time will be reset, and the item will have another minute to be read before expiration.

### TTA Modes

In various examples and implementations, TTA may have two different modes, single and continuous:

Single TTA—Key prefixes are configured with a value TTA_SECONDS, indicating the number of seconds to maintain the item in cache until first access. If the item is accessed within TTA_SECONDS, it remains in cache until deletion/expiration/eviction. If the item is not accessed in TTA_SECONDS, it is removed from cache. In addition, the mechanisms discussed herein are performed only once on the first access.

Continuous TTA—Key prefixes are configured with a value TTA_SECONDS, indicating the number of seconds to maintain the item in cache since the last access. If the item is accessed with TTA_SECONDS, it may remain in cache for another TTA_SECONDS. This is essentially a key prefix based, customized retention period.

### Testing TTA on a Key Prefix

In order to evaluate whether TTA optimization makes sense for a use case, it may need to first be canaried on a small set of machines to evaluate whether a significant amount of memory is saved and/or the overall hit rate is not impacted for the use case. The following discussion provides example implementations on which testing may occur. In various examples, TTA may be controlled through the MEMCACHE startup GFLAG tta_enabled.

On startup, if the tta_enabled flag is set, a list of prefixes to TTA mappings are parsed from a configurator file.

Memcache may build a trie with these prefixes, storing the required TTA for that prefix in the leaf node. On a set, the trie is walked, e.g., to search for a specific string or other operation. If a match is found:
The item is marked to indicate that TTA is active.
The original TTL is stored in the leaf node of the trie.
The expiry time of the item is set to TTA_seconds.

On a get, the item flag is checked. If TTA was marked when the item was set:
The expiry time of the item is updated with (TTL-TTA) seconds.
The flag is unset on the item to indicate that its TTA is no longer active.

### TTA Example Implementations

Example implementations for TTA experiments may include the following operations:
(1) Pick a Prefix
(2) Determine TTA
(3) Run a Canary
(4) Configure TTA
(5) Increase Composition Sampling
(6) Configurator Canary on Canary Tier
(7) Add Hosts to Canary Tier
(8) Increase Dynamic Sampling on Canary Tier and in Region
(9) Monitor Canary Performance

(1) Pick a Prefix: Pick a prefix to run TTA experiment on, based on the amount of memory it takes up. Prefixes taking up more memory are likely to earn bigger return when capped with TTA. In an example, foo-bar may take up 10% of the system but is reducible with TTA.

(2) Determine TTA: Determine the ideal point where the use case no longer benefits from additional retention.

In various examples, “MEMCACHEInternal Events” may provide a good approximation of key behavior. Once a value is determined, binary search approach (or concurrent canaries with different values) may be used to determine the ideal TTA for a key prefix. Refer to the following queries as references—using a Universal Packaging Tool (UPT) file as an example, it may be seen that 40% of items expired and never read, and 57% of items were read once or less. Another example may show 65% of reads occurring in the first 300 seconds, and 87% of reads in first 900 seconds.

In some examples, other processes, like MemCAB, may be fairly time consuming. In such cases, Memcache Internal Events may be used. In particular, working set analysis data and/or MemCAB may help with this. Specifically, a plot showing a retention vs. hit rate curve may illustrate where simulated increased retention no longer improves hit rate. The initial TTA may be based around that.

In an example, if an operation, e.g., “foo-bar” seems to not benefit much from anything after 10 minutes (min.) retention, then a TTA of 10 minutes may be tested.

(3) Run a Canary: A zero-sized canary tier may be applied to test TTA changes. In an example, when a canary is treated a tier, its name may be defined.

(4) Configure TTA: A TTA configuration may be added to the prefix to be tested.

(5) Increase Composition Sampling: A sample rate increase may be necessary to achieve a good measurement of composition on the canary machine(s). In an example, by default, four samples may be taken every iteration. In some cases, a higher sample rate, e.g., a 100× increase, may be necessary to obtain a more ideal amount.

(6) Configurator Canary on Canary Tier: This may be implemented for canary testing. For example, in a Configurator directory, a configurator canary may be run on the MEMCACHE canary.

(7) Add Hosts to Canary Tier: Once new hosts are added to a canary tier, they may be automatically warm rolled with the TTA and Composition configuration changes, which were previously added.

(8) Increase Dynamic Sampling on Canary Tier and in Region: Dynamic sampling may allow improved signal for a particular hit rate. For example, one may be unable to sample for a tier only for a host. So, to find out all the hosts in your MEMCACHE canary tier, and for each one, the following may be run:

If there are not enough samples for this key prefix in mcrouter requests, it may be necessary to add sampler for non-canary boxes on the tier.

(9) Monitor Canary Performance: In some examples, Scuba may be used to monitor both hit rate and composition during and after an experiment. Some example queries may include:

Monitoring Hit Rate, such as (a) a hit rate of the prefix in the region; and/or (b) a hit rate of the prefix canary in a host.

Monitoring Composition, such as (a) a composition of the prefix in the region; and/or (b) a composition of the prefix in a canary host.

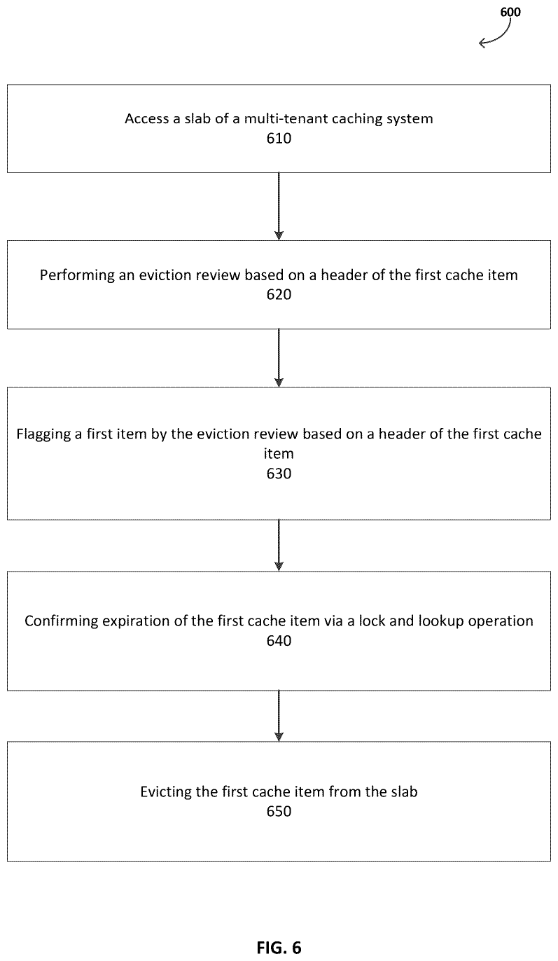

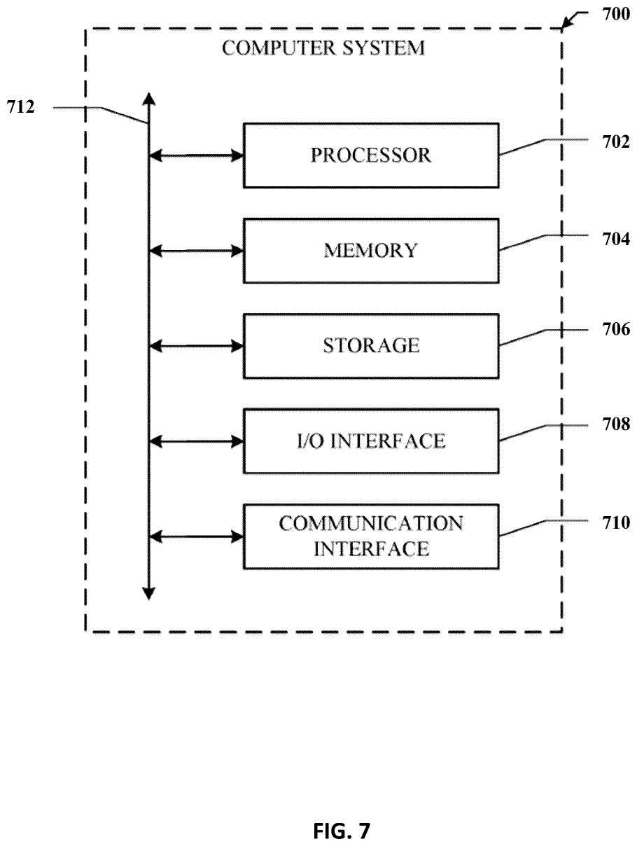

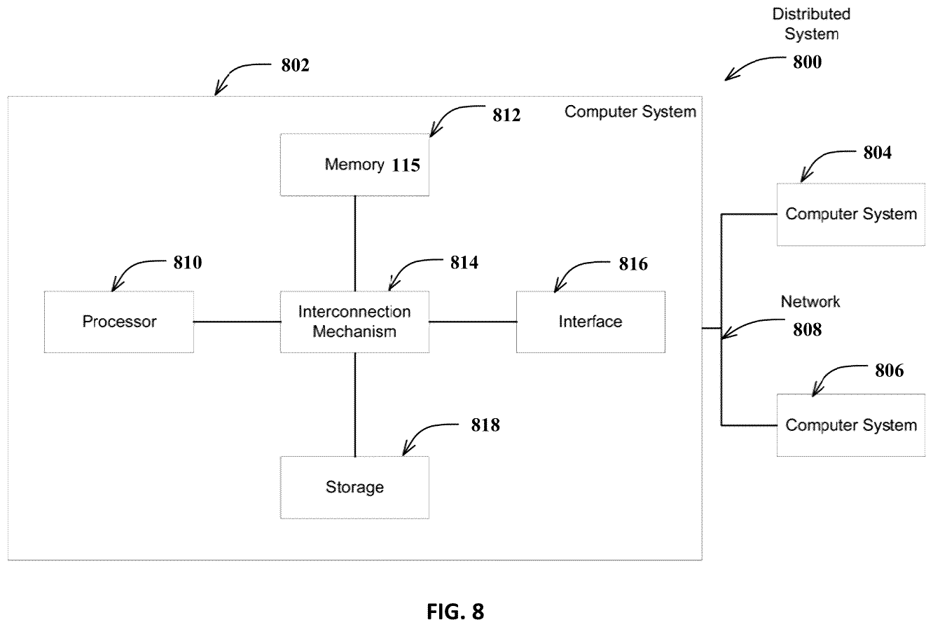

FIG. 6 illustrates a flowchart providing a cache eviction enforcement operation 600 in accordance with various examples discussed herein. At block 610, a device (e.g., computing system 700 of FIG. 7, distributed computer system 800 of FIG. 8) may access a slab of a multi-tenant caching system. The multi-tenant caching system may comprise servers in a hosted environment configured to host multiple users. The multi-tenant caching system may utilize one or more networks, including a cloud network, and one or more databases, which may be shared among tenants. The slab may be one of a plurality of slabs forming a slab space. In various examples, slabs may be defined by a memory size (e.g., 4 MB) and class size (e.g., 64 bytes). Slabs may be configured to store cache items within its defined class size. The class size, for example, may define a byte size. The class size corresponds to a size of cache items stored within the slab. Cache items within a slab of a given class size may be less than or equal to the class size. For example, cache items of 64 bytes or less may be stored within a slab of class size of 64 bytes. The slab may, for example, have a 4 MB memory size, and can contain 62,500 64-byte cache items.

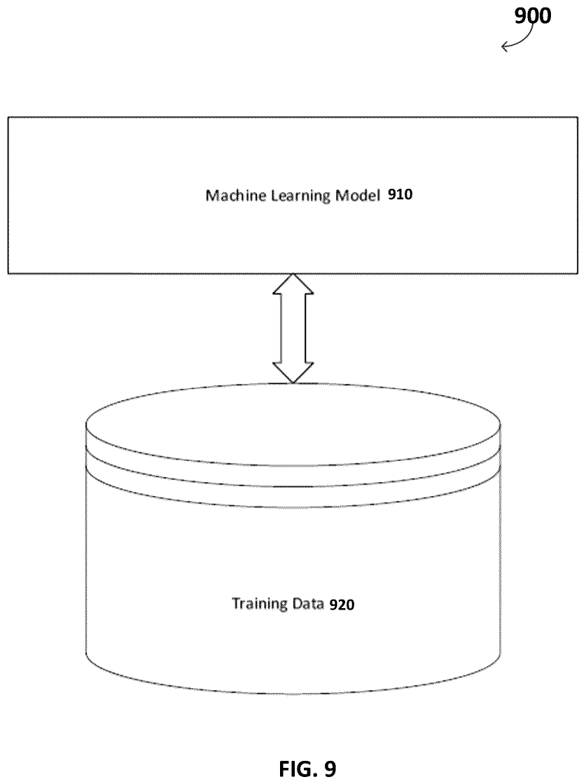

At block 620, a device (e.g., computing system 700, distributed computer system 800) may perform an eviction review based on a header of the first cache item. The header may include at least one integer indicative of the retention time. The eviction review may sequentially reap through the slab based on the class size. In some examples, the eviction review may look at a time to access and/or the expiry time, which may be based on at least one of historical access of the first cache item, a time to live (TTL) associated with the first cache item, or a machine learning model trained on access times of other cache items. In some examples, the historical access may relate to how often the first cache item has been accessed within a given period of time. The historical access may be based, at least in part, on historical access of similar cache items. A machine learning model (e.g., machine learning model 910 of FIG. 9) may analyze sets of cache items and associated access times, which may include historical access times, predicted access times, and the like, to determine a retention time for the first cache item. It will be appreciated that any of a plurality of training data may be used to train the machine learning module to predict a time to access. Time to access (TTA) may be based on one or more factors, including but not limited to the historical access of the first cache item (e.g., Set Requests, Get Requests, etc.), similar cache items, other cache items within the slab, available memory, and the like.

At block 630, a device (e.g., computing system 700, distributed computer system 800) the eviction review may flag a first item in the slab based on a header of the first cache item. The header may be indicative of an expiry time. In some cases, the expiry time may be a Time to Access. In some examples the expiry time may be an updated expiry time from an initial expiry time associated with the first cache item. In other examples, the expiry time may be updated in response to a Set Request (see, e.g., FIG. 5A) or a Get Request (see, e.g., FIG. 5B). In an example, determining the expiry time may include determining an initial expiry time associated with the first cache item, and updating the expiry time to a time to access when the initial expiry time is greater than the time to access. In another example, the expiry time may be updated to a sum of a current time and a time to access, when the sum of a current time and a time to access is less than the expiry time. In some cases, these updates may occur in response to a Set Request or a Get Request.

At block 640, a device (e.g., computing system 700, distributed computer system 800) confirm expiration of the first cache item via a lock and lookup operation. This may occur, for example, via the process discussed in FIG. 3.

At block 650, a device (e.g., computing system 700, distributed computer system 800) may evict the first cache item from the slab. In various examples, as discussed herein, the eviction review iterates through headers associated with the cache items. The eviction review may iterate through headers based on a class size. The reaper may evict the first cache item from the slab when the eviction review determines that the expiry time is exceeded. Evicting the first cache items may remove the first cache item from the slab. It should be appreciated that any of a plurality of reaping techniques and eviction considerations may be applied and fall within the scope of the various examples discussed herein.

FIG. 7 illustrates an example computer system 700. In particular exemplary embodiments, one or more computer systems 700 perform one or more steps of one or more methods described or illustrated herein. In particular exemplary embodiments, one or more computer systems 700 provide functionality described or illustrated herein. In particular exemplary embodiments, software running on one or more computer systems 700 performs one or more steps of one or more methods described or illustrated herein or provides functionality described or illustrated herein. Particular embodiments may include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular exemplary embodiments, computer system 700 includes a processor 702, memory 704, storage 706, an input/output (I/O) interface 708, a communication interface 710, a bus 712 and a shuffler module 714. Although this disclosure describes and illustrates a particular computer system having a particular number of particular components in a particular arrangement, this disclosure contemplates any suitable computer system having any suitable number of any suitable components in any suitable arrangement.

In particular exemplary embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular exemplary embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular exemplary embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor. In some example embodiments, the shuffler module 714 may defragment one or more target entities (e.g., a channel(s), spectrum, etc.) by, for example, reconfiguring at least one existing spectrum path associated with an optical channel in a set of optical channels, as described above.

In particular exemplary embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular exemplary embodiments, processor 702 may execute instructions in one or more internal registers or internal caches or in memory 704 (as opposed to storage 706 or elsewhere) and operates on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular exemplary embodiments, one or more memory management units (MMUs) may reside between processor 702 and memory 704 and may facilitate accesses to memory 704 requested by processor 702. In particular exemplary embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular exemplary embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular exemplary embodiments, storage 706 is non-volatile, solid-state memory. In particular exemplary embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular exemplary embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular exemplary embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular exemplary embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

FIG. 8 shows a block diagram of a specially configured distributed computer system 800, in which various aspects may be implemented. As shown, the distributed computer system 800 includes one or more computer systems that exchange information. More specifically, the distributed computer system 800 includes computer systems 802, 804, and 806. As shown, the computer systems 802, 804, and 806 are interconnected by, and may exchange data through, a communication network 808. The network 808 may include any communication network through which computer systems may exchange data. To exchange data using the network 808, the computer systems 802, 804, and 806 and the network 808 may use various methods, protocols and standards, including, among others, Fiber Channel, Token Ring, Ethernet, Wireless Ethernet, Bluetooth, IP, IPV6, TCP/IP, UDP, DTN, HTTP, FTP, SNMP, SMS, MIMS, SS6, JSON, SOAP, CORBA, REST, and Web Services. To ensure data transfer is secure, the computer systems 802, 804, and 806 may transmit data via the network 808 using a variety of security measures including, for example, SSL or VPN technologies. While the distributed computer system 800 illustrates three networked computer systems, the distributed computer system 800 is not so limited and may include any number of computer systems and computing devices, networked using any medium and communication protocol.

As illustrated in FIG. 8, the computer system 802 includes a processor 810, a memory 812, an interconnection element 814, an interface 816 and data storage element 818. To implement at least some of the aspects, functions, and processes disclosed herein, the processor 810 performs a series of instructions that result in manipulated data. The processor 810 may be any type of processor, multiprocessor or controller. Example processors may include a commercially available processor such as an Intel Xeon, Itanium, Core, Celeron, or Pentium processor; an AMD Opteron processor; an Apple A10 or A5 processor; a Sun UltraSPARC processor; an IBM Power5+ processor; an IBM mainframe chip; or a quantum computer. The processor 810 is connected to other system components, including one or more memory devices 812, by the interconnection element 814.

The memory 812 stores programs (e.g., sequences of instructions coded to be executable by the processor 810) and data during operation of the computer system 802. Thus, the memory 812 may be a relatively high performance, volatile, random access memory such as a dynamic random access memory (“DRAM”) or static memory (“SRAM”). However, the memory 812 may include any device for storing data, such as a disk drive or other nonvolatile storage device. Various examples may organize the memory 812 into particularized and, in some cases, unique structures to perform the functions disclosed herein. These data structures may be sized and organized to store values for particular data and types of data.

Components of the computer system 802 are coupled by an interconnection element such as the interconnection mechanism 814. The interconnection element 814 may include any communication coupling between system components such as one or more physical busses in conformance with specialized or standard computing bus technologies such as IDE, SCSI, PCI and InfiniBand. The interconnection element 814 enables communications, including instructions and data, to be exchanged between system components of the computer system 802.

The computer system 802 also includes one or more interface devices 816 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 802 to exchange information and to communicate with external entities, such as users and other systems.

The data storage element 818 includes a computer readable and writeable nonvolatile, or non-transitory, data storage medium in which instructions are stored that define a program or other object that is executed by the processor 810. The data storage element 818 also may include information that is recorded, on or in, the medium, and that is processed by the processor 810 during execution of the program. More specifically, the information may be stored in one or more data structures specifically configured to conserve storage space or increase data exchange performance. The instructions may be persistently stored as encoded signals, and the instructions may cause the processor 810 to perform any of the functions described herein. The medium may, for example, be optical disk, magnetic disk or flash memory, among others. In operation, the processor 810 or some other controller causes data to be read from the nonvolatile recording medium into another memory, such as the memory 812, that allows for faster access to the information by the processor 810 than does the storage medium included in the data storage element 818. The memory may be located in the data storage element 818 or in the memory 812, however, the processor 810 manipulates the data within the memory, and then copies the data to the storage medium associated with the data storage element 818 after processing is completed. A variety of components may manage data movement between the storage medium and other memory elements and examples are not limited to particular data management components. Further, examples are not limited to a particular memory system or data storage system.

Although the computer system 802 is shown by way of example as one type of computer system upon which various aspects and functions may be practiced, aspects and functions are not limited to being implemented on the computer system 802 as shown in FIG. 8. Various aspects and functions may be practiced on one or more computers having a different architectures or components than that shown in FIG. 8. For instance, the computer system 802 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 802 may be a computer system including an operating system that manages at least a portion of the hardware elements included in the computer system 802. In some examples, a processor or controller, such as the processor 810, executes an operating system. Examples of a particular operating system that may be executed include a Windows-based operating system, such as, Windows NT, Windows 2000 (Windows ME), Windows XP, Windows Vista or Windows 6, 8, or 6 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor 810 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C#(C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

FIG. 9 illustrates a framework 900 employed by a software application (e.g., algorithm) for evaluating cache items and objects and determining expiration times. In various examples, the framework 900 may be hosted remotely. Alternatively, the framework 900 can reside within the computing system 700 shown in FIG. 7 and/or be processed by the distributed computing system 800 shown in FIG. 8. The machine learning model 910 is operably coupled to the stored training data in a database 920.

In an example, the training data 920 can include attributes of thousands of objects. For example, the objects may be cache items and associated TTA, TTL, access data, expiration data, and the like. Attributes may include but are not limited to historical access, similar objects and related data, such as TTA, TTL, expiration, and other heuristics, etc. The training data 920 employed by the machine learning model 910 may be fixed or updated periodically. Alternatively, the training data 920 may be updated in real-time based upon the evaluations performed by the machine learning model 910 in a non-training mode. This is illustrated by the double-sided arrow connecting the machine learning model 910 and stored training data 920.

In operation, the machine learning model 910 may evaluate attributes of various code elements and functionalities (e.g., computing system 802, distributed system 802, etc.). For example, code elements of a software product software libraries, and or previously evaluated features may provide attributes related to code elements, whether an intended functionality was achieved, and whether the code element update achieves its intended functionality. The attributes of the evaluated elements (e.g., from a software product) are then compared with respective attributes of stored training data (e.g., previously evaluated software products and/or code elements).

The likelihood of similarity between each of the obtained attributes (e.g., of a software product, computing system 802, distributed system 800, etc.) and the stored training data 920 (e.g., previously evaluated data) is given a confidence score. In one example, if the confidence score exceeds a predetermined threshold, the attribute(s) is included in a description that is ultimately communicated to the user via a user interface of a computing device (e.g., computing system 802, distributed computing system 800, etc.). In another example, the description may include a certain number of attributes which exceed a predetermined threshold to share with the user. The sensitivity of sharing more or less attributes may be customized based upon the needs of the particular user.

### B. Customized Computer Vision-Oriented Convolutional Neural Networks

CNNs are being used to solve a vast array of challenging machine learning problems. These may include, for example, natural language processing, computer vision and recommendation systems. CNNs comprise a series of computation layers, where each layer takes the output of the preceding layer as its input. In so doing, CNNs may achieve extraordinary results with regard to image object recognition accuracy, object detection and classification.

CNNs for video and image quality improvement, de-noise, super-resolution, and similar features traditionally utilize many different algorithms. Many of those algorithms often require the dedicated hardware circuits to support the specific and different functions which cannot be shared among these algorithms due to the cost and performance reasons. However, the trade-off for these results is high computational cost. Especially in dynamic environments, video and image quality features and related operations require significant computational resources.

Machine learning and inference provide a couple approaches to address computer-vision related quality features. In some examples, machine learning may be used to find the optimized kernels for each feature, and these kernels may be provided to the general-purpose CNN circuit to get the final solutions. But a general-purpose graphics processing unit (GPU) solution is, again, very costly and inefficient for Computer Vision (CV)-based CNNs.

The present application describes systems, methods, devices, and computer program products for convolutional neural networks (CNN) applicable for image processing and computer vision-oriented operations. The CNN system may include dedicated blocks, for specific image processing operations, to significantly improve efficiency and reduce bandwidth and computational costs. CNN systems and methods, as discussed herein, may include a pre-processing module to at least convert initial image data to a first format, a CNN core to process image data according to convolution parameters and generate processed image data, a post-processing module to convert the processed image data to output packets, and a control module to manage communications and operations between various modules.

Aspects of the present disclosure provide a customized CNN system providing an efficient, customized end-to-end solution. Examples include customized CNN circuit designs providing high performance while using less power and less memory bandwidth than traditional CNNs. It will be understood the methods and apparatuses described in the present application may allow for an elegant solution to minimize processing power and reduce costs associated with multiple back and forth communication between an external memory, a CNN and a processor.

The CNN systems, methods, and devices discussed herein provide significant improvements and efficiencies for image quality improvement, noise reduction operations, and resolution improvements, among others. Rather than executing a routine set of operations for disparate features, and manual analysis, the present disclosure provides real-time, energy-efficient techniques to optimize image operations. For example, the machine learning techniques discussed herein enable optimal kernels to be determined and applied to an image, and generate customized and computationally-efficient scaling operations.

The block-based design of the CNN system efficiently distributes operations to respective processing entities, e.g., pre-processing module, control module, CNN core, and the post-processing module. This unique CNN circuit design results in less power, less memory bandwidth, and higher performance, compared to traditional CNNs. It further eliminates the needs for dedicated circuits for each unique processing operation.

Moreover, the CNN systems provided herein enable dynamic operation and functional testing in a live environment, thereby providing recognition, responses, and solutions to operational and functional issues that may not be recognized or caught during traditional static testing and implementations. In particular, the example systems, methods, devices, and computer program products enable real-time adaptation to dynamically changing environments. Each dedicated system block targets specific functions, while the control module ensures efficient communication and processing between the modules. For example, the CNN core, with its dedicated buffers (e.g., internal, in-place circular buffers), enables specific and customized kernel parameters to be defined, based on the desired scaling operation. The ReLU circuit is further designed to feed layer result(s) back to the in-place circular buffers for additional layer processing, or feed into the post-processing module, where the image information may be delivered, in a desired format, to an output device, such as an external memory.

Previous techniques often required manual testing and/or development of specific tests to process certain image types or color spaces, or to examine and determine various image scaling aspects, such as optimal kernel parameters. However, the present invention provides improved techniques, which may include an automated and/or machine learning-based, comprehensive implementations to analyze image types, color spaces, scaling operations, conversions, and provide dedicated operations to efficiently process each image and standardize operations. The examples and techniques discussed herein significantly improve upon traditional manual or “checklist” based methods, instead analyzing updates from a dynamic, live, and real-time perspective. Such techniques further enable customization and optimization, which may be difficult using traditional methods. In particular, specific dimensions and characteristics may be weighted and/or considered in the dynamic testing and operation techniques.

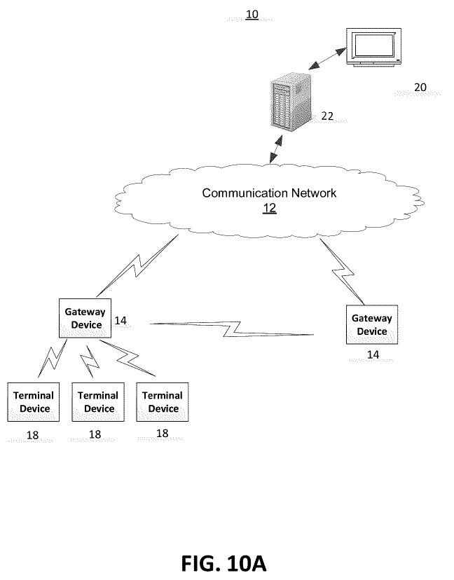

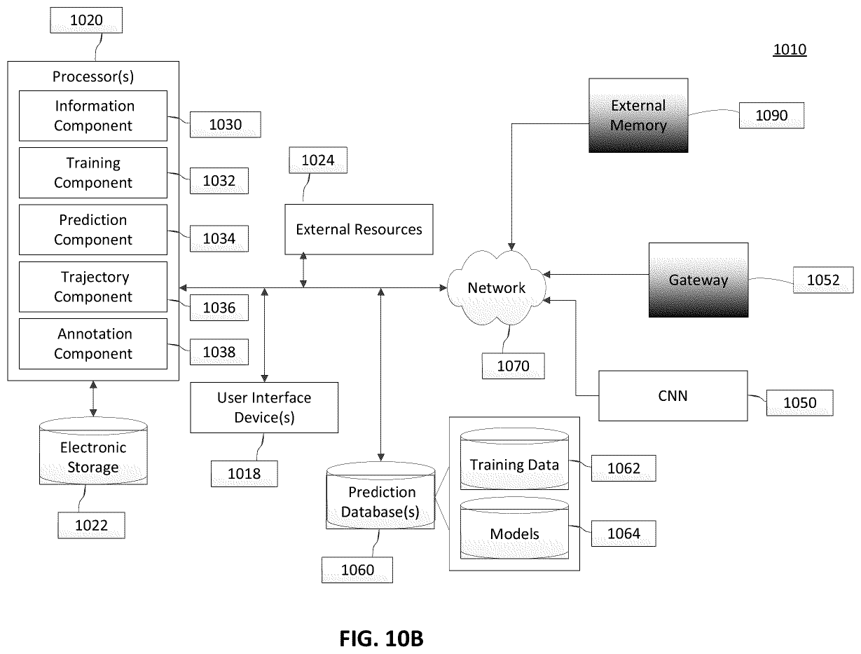

FIG. 10A is a diagram of an example communication system 10 in which one or more disclosed embodiments may be implemented. As shown in FIG. 10A, the communication system 10 includes a communication network 12. The communication network 12 may be a fixed network, e.g., Ethernet, Fiber, ISDN, PLC, or the like or a wireless network, e.g., WLAN, cellular, or the like, or a network of heterogeneous networks. For example, the communication network 12 may comprise other networks such as a core network, the Internet, a sensor network, an industrial control network, a personal area network, a fused personal network, a satellite network, a home network, or an enterprise network for example.

It will be appreciated that any number of gateway devices 14 and terminal devices 18 may be included in the communication system 10 as desired. Each of the gateway devices 14 and terminal devices 18 are configured to transmit and receive signals via the communication network 12 or direct radio link. The gateway device 14 allows wireless devices, e.g., cellular and non-cellular as well as fixed network devices, e.g., PLC, to communicate either through operator networks, such as the communication network 12 or direct radio link. For example, the devices 18 may collect data and send the data, via the communication network 12 or direct radio link, to an application 20 or devices 18. Further, data and signals may be sent to and received from the application 20 via a service Layer 22, as described below. In one embodiment, the service Layer 22 may be a PCE. Devices 18 and gateways 14 may communicate via various networks including, cellular, WLAN, WPAN, e.g., Zigbee, 6LoWPAN, Bluetooth, direct radio link, and wireline for example.

According to an aspect of the present application, the architecture may include machine learning architecture, as illustrated in FIG. 10B. In one embodiment, the architecture may reside at a server. Alternatively, the architecture may reside on a consumer product or device, such as a computer system. More specifically, the architecture may include a processor operably coupled to one or more databases that may include the CNN. In an embodiment, the processor may be reference indicator 1020 in FIG. 10B. The CNN may be reference indicator 1050 as depicted in FIG. 10B. The CNN may include one or more blocks. Each of the one or more blocks may include, for example, at least one of: an information component 1030, a training component 1032, a prediction component 1034, a trajectory component 1036, or an annotation component 1038. The processors may be in communication with electronic storage 1022, external resources 1024, user interface device(s) 1018, prediction database(s) 1060, which may include training data 1062 and/or models 1064. The processors 1020 may also be in network communication with one or more external memories 1090, gateway devices 1052, or CNNs 1050.

According to an embodiment, data may be located in an external memory, such as for example, a DDR memory. The data may include any one or more of image data or video data. In an example, the data may include pixels. In an example, the external memory may be depicted as reference indicator 1090 in FIG. 10B. External memory 1090 may communicate with the system including the processor 1020 and CNN 1050 via network 1070.

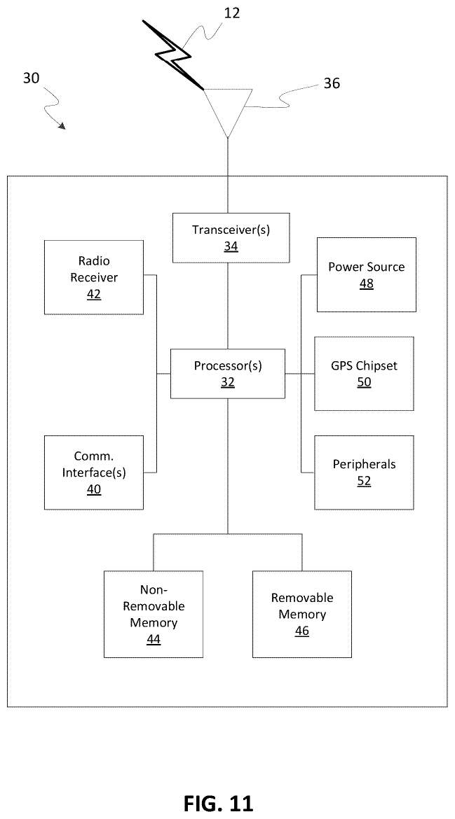

FIG. 11 illustrates a block diagram of an exemplary hardware/software architecture of user equipment (UE) 30. The architecture may be used in conjunction with the system depicted in FIG. 10. As shown in FIG. 11, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an exemplary embodiment, the camera 54 is a smart camera configured to sense images appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-Layer programs (e.g., browsers) and/or radio access-Layer (RAN) programs and/or other communications programs. The processor 32 may also perform security operations such as authentication, security key agreement, and/or cryptographic operations, such as at the access-Layer and/or application Layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another embodiment, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

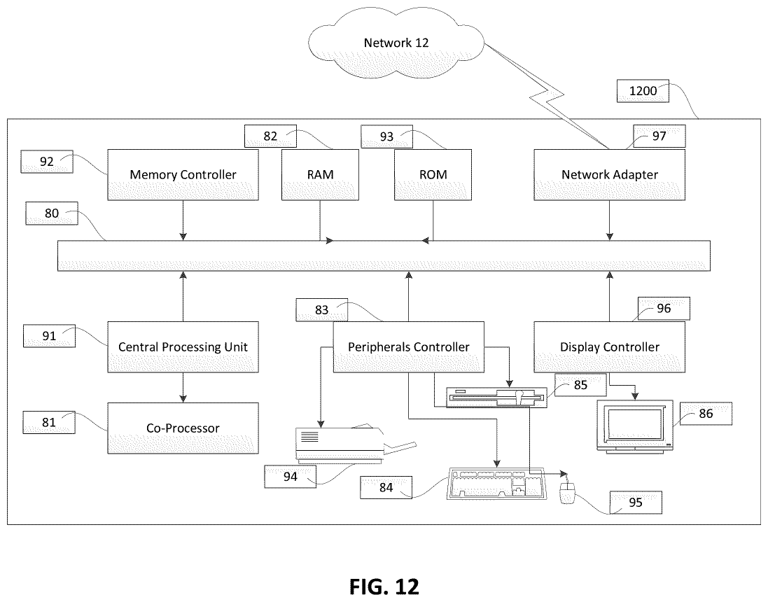

FIG. 12 is a block diagram of an exemplary computing system 1200 which may also be used to implement components of the system or be part of the UE 30. The computing system 1200 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 1200 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 1200 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 1200 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 1200. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 1200 may contain communication circuitry, such as for example a network adaptor 97, that may be used to connect computing system 1200 to an external communications network, such as network 12, to enable the computing system 1200 to communicate with other nodes (e.g., UE 30) of the network.

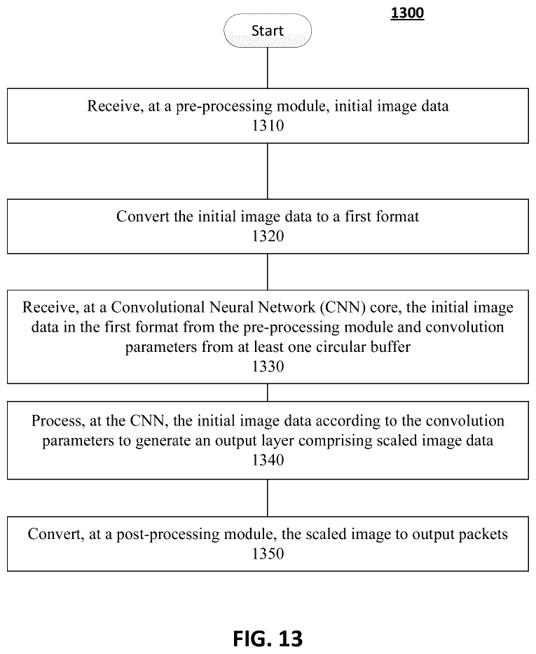

According to an aspect of this application, FIG. 13 illustrates a flowchart of an example process 1300. In some implementations, one or more process blocks of FIG. 13 may be performed by a device. The example process 1300 may be an image operation, including but not limited to a scaling operation (e.g., up-scaling, down-scaling), a resizing operation, a noise reduction operation, or a resolution improvement operation, among other operations.

As shown in FIG. 13, block 1310 may include receiving, at a pre-processing module, initial image data. Such initial image data may be raw image data, pre-processed image data, data in a first color space, and the like. For example, initial image data may be in a color space including but not limited to RGB, YUV, HSL, or CMYK.

At block 1320, the pre-processing module may convert the initial image data to a first format. The first format may be a particular color space, such as converting the image data to RGB. In some examples, the initial image data may go through color space conversion and/or chroma up-sampling. For example, Chromo420 data may go through up-sampling to Chroma44, or Chroma444 data may go through color space conversion, e.g., to RGB444. Blocks 1310 and 1320 may be optional, and various aspects include one or both operations.

At block 1330, a convolutional neural network core module may receive the initial image data in the first format from the pre-processing module or the previous layer result from one of the circular buffers, and convolution parameters from the kernel buffer which has the pre-loaded parameters for each CNN layer process. The CNN core may include one or more in-place internal circular buffer. These may include, but are not limited to, and aux circular buffer, a main circular buffer, a kernel buffer, and a buffer for ReLU parameters. In some examples, the internal circular buffers may feed data into convolution circuit and layer adder to manage optimization operations. The buffers may include temporary buffers and/or serve as a location where a layer output may be saved.

A multiplexer, i.e., mux unit, may receive the initial image data, previous layer result, and parameters from one or more buffers. In some examples, the multiplexer may be managed, at least in part, by the control module. Such data may then be fed into the convolution circuit to process the input image data (the initial image or the previous layer result) and determine the next layer.

At block 1340, the CNN may process the input image data according to the convolution parameters to generate an output layer comprising processed image data. The convolution parameters may include kernel parameters associated with a scaling operation and may be determined based on at least one machine learning module, which may be external or internal the CNN core module. The result image can be fed back into the circular buffer or transmitted into the post-process unit.

At block 1350, at a post-processing module, the scaled image may be converted to output packets. The output packets may optionally be provided to an external device, such as an external memory. In various examples, the output packet format may be customized, e.g., depending on where they are to be delivered.

Accordingly, the discussed systems and methods may provide video and image scaling, frame rate conversions, noise reductions, and other image operations. For example, a video may be converted from 30 frames per second (fps) to 60 fps. In another example, a video may be converted from 120 fps down to 60 fps.

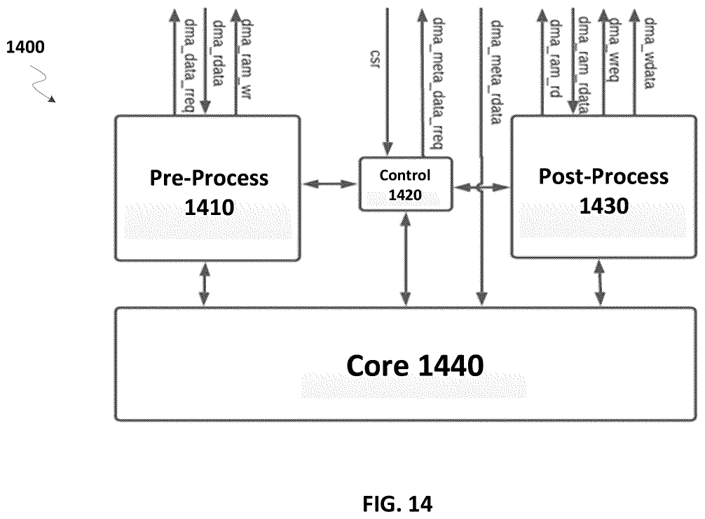

To further explain the concepts described above, the embodiment depicted in FIG. 14 shows a block-based CNN system architecture. The CNN system may include a Pre-Processing block 1410, a CNN Core 1440, a Post-Processing block 1430, and a Control block 1420. The CNN system architecture 1400 and its blocked design significantly reduces system bandwidth and power compared to traditional convolutional neural network arrangements.

In various examples, at least one in-place circular buffer may be included and configured to make left-neighbor data and input data into a continuous data space. Instruction-based operations enable the internal in-place circular buffer to function similarly to general purpose registers of a CPU and give firmware or drivers full control of the buffer.

As further discussed herein, the Pre-Process module 1410 and Post-Process module 1430 may enable up-sampling of images, from end-to-end, to obtain a high quality vision effect. In addition, kernels, such as a super-resolution kernel re-configuration reduces Depth-to-Space conversions with power and performance improvements.

The Pre-Process block 1410 may handle input channel data reads, chroma up-sampling, color space conversion, and first layer data buffer management.

The Core block 1440 primarily processes layer convolutions, ReLU, layer copies, layer adds, intermediate layer data buffer management, and meta data management. Metadata may include, but is not limited to kernel and ReLU data.

The Control block 1420 may communicate with each of the other blocks-Pre-Process 1410, Core 1440, and Post-Process 1430—with the pre-generated different control signals for the different pipeline stages to orchestrate communications between and operations of the other systems for seamless operation and integration.

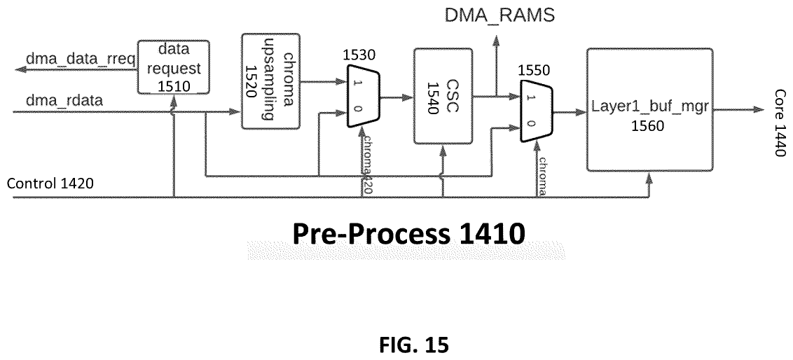

FIG. 15 provides an example architecture of the pre-process block. According to various aspects data request 1510 may receive block level parameters from the control block 1420, and generate a request to a memory, e.g., Direct Memory Access (DMA). Read data returned from the memory (e.g., referred to herein as DMA) may feed into one of three modules: Chroma Up-sampling 1520, Color Space Conversion 1540, or layer1_buf_mgr 1560—based on the input data formats.

In a first example, read data including Chroma420 data may go to the Chroma Up-Sampling module 1520. The Up-Sampling module 1520 may convert chroma420 data to chroma444. From there, a verification 1530 may determine whether data may be passed to the CSC. In another example, up-sampled chroma 444 data may pass through verification 1530 and to the CSC 1540. Chroma420 data may be prevented from being passed to the CSC 1540.

In yet another example, read data including Chroma444 data may go to the Color Space Conversion (CSC) module 1540. The CSC may convert Chroma444 to RGB444 into the DMA-shared buffer. In some examples, this may occur if output needs to add back source RGB data. As mentioned above, the CSC 1540 may receive data up-sampled from the up-sampling module 1520 or directly from the input, and further convert the up-sampled data, e.g., to RGB. In some examples, input/output CSC format conversion may be supported when the input is in RGB or Y formats. The CSC 1540 may also support down-scaling or even no-scaling. According to some aspects, a no source add back may be supported, especially when the ADD input from MUX is zero.

In a third example, read data including RGB data may go to a buffer manager, e.g., layer1_buf_mgr 1560. Layer1_buf_mgr 1560 may also receive data from the CSC 1540, once it has passed a verification 1550, similar to block 1530, to ensure it is in an acceptable format. For example, verification 1550 may receive chroma data directly from the control block 1420. Layer1_buf_mgr 1560 may maintain a block level left column and top line buffer and combine input data with top and left buffer to form input data to directly feed core 1440.

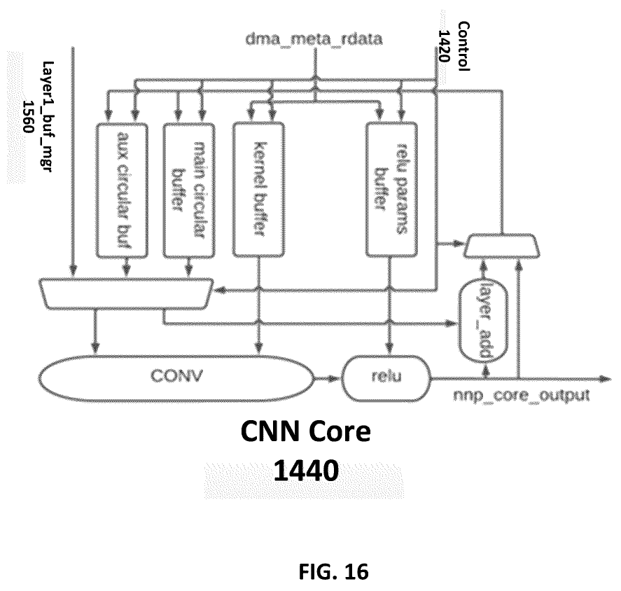

FIG. 16 illustrates an example architecture for the CNN Core 1440. The core 1440 may accept metadata from the DMA (e.g., dma_meta_rdata), and may write the data into a kernel and ReLU buffer, e.g., for CNN operations. Internal, in-place circular buffers and meta buffers may be applied and controlled by Control module 1420 (also referred to herein as Control 1420). Such buffers may include an aux circular buffer, a main circular buffer, a kernel buffer, and ReLU parameter buffer.

Control information may be used to select data from at least one of a layer1_input, such as the layer_buf_mgr 1560, or one or two internal circular buffers, such as the aux buffer and/or main circular buffer. The selected control data may then be fed into the convolution circuit (CONV) and layer adder.

The convolution circuit may receive input data from a multiplexer/mux unit, for example, and may receive kernel parameters from a kernel buffer. Convolution results may then be fed into the ReLU circuit. ReLU parameters may also be fed into the ReLU circuit. The ReLU circuit, along with any special functions (e.g., from ReLU params buffer), may produce a layer result. The layer result may be fed back to the in-place circular buffer, e.g., for the next layer (see, e.g., layer add), or sent to the Post-Process block 1430 (also referred to herein as Post-Process architecture 1430) if the layer result is the final layer.

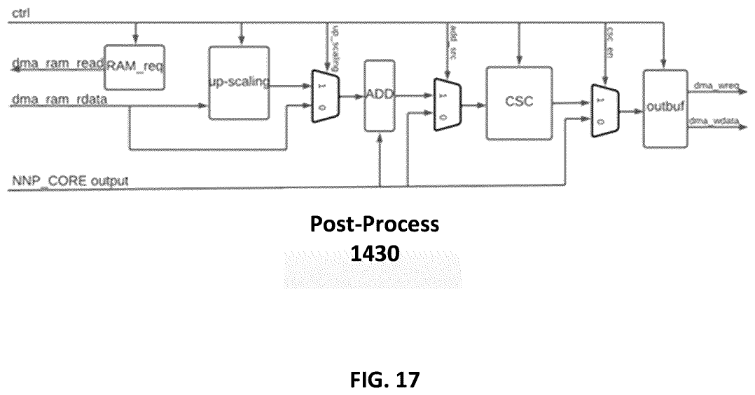

FIG. 17 illustrates the Post-Process architecture 1430. A RAM_req moudule may request block level signals from Control 1420 to generate dma_ram_read, which reads source RGB data as needed. As discussed above, at Pre-Process 1410, image data may be up-scaled to RGB. DMA_ram_rdata feeds into an up-scaling module, which generates up-scaling output in the raster order to match the core output.

The ADD block can add the core output with source RGB data from mux logic to pick up-scaling data or non-scaling data. The CDC may perform color space conversion from RGB444 to chroma444, then from chroma444 to chronma420. The CSC input from the mux logic may directly provide the output from the Core output and/or the result from the ADD circuit. Accordingly, the outbuf provides global output parameters from control 1420, and receives output data from the CSC and/or the core 1440 (e.g., core 1440 of FIG. 15) to form output packets to DMA.

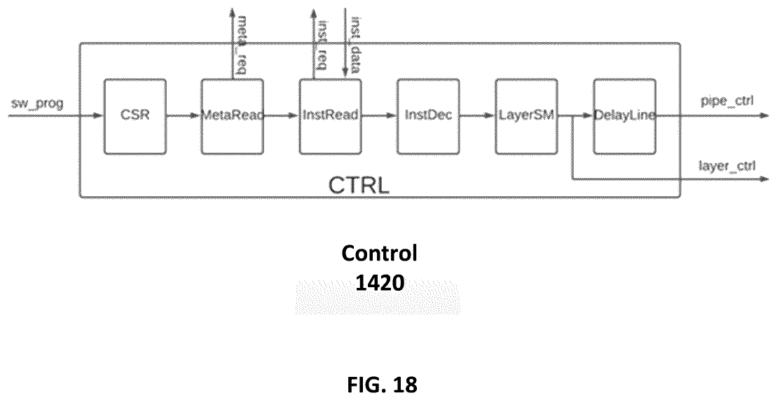

FIG. 18 illustrates an example architecture of control 1420. As discussed herein, the control block 1420 enables seamless communication and integration between the Pre-Process, Post-Process, and Core blocks. At the Control block, a software program's global parameters passes through the CSR block and serves to prepare all other metadata in the memory. The MetaRead block responds to the CSR block to send metadata read requests, as needed. The metadata read return may go directly to metadata buffer of Core 1440.

Once the MetaRead setup cycle is complete, InstRead module may request and receive instructions. For example, InstRead may send instruction read requests to stream in block-based through the DMA. In some examples, such read requests occur if InstRead has the buffer to receive additional instructions. As long as instructions are available, the InstDec block may decode the instructions for hardware execution.

When decoded instructions are available for a block layer to run, LayerSM will start and send the layer level and pipeline level control signals to coordinate other Core systems to run.

The DelayLine block may provide a phase alignment process. For example, once pipeline level control signals are generated, such control signals pass through the DelayLine block to perform phase alignment. Aligned pipeline control signals may then be sent to other blocks and modules to complete CNN operations at the different pipeline stages.

Based on the foregoing disclosure, it should be apparent to one of ordinary skill in the art that the embodiments disclosed herein are not limited to a particular computer system platform, processor, operating system, network, or communication protocol. Also, it should be apparent that the embodiments disclosed herein are not limited to a specific architecture.

It is to be appreciated that embodiments of the methods and apparatuses described herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features described in connection with any one or more embodiments are not intended to be excluded from a similar role in any other embodiments.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method for cache eviction enforcement, comprising:
accessing a slab of a multi-tenant caching system, wherein the slab is defined by a memory size and a class size, the class size corresponding to a size of cache items stored within the slab;
performing an eviction review by sequentially reaping through the slab, based on the class size;
flagging a first cache item by the eviction review based on a header of the first cache item, wherein the header comprises a prefix indicative of an expiry time;
confirming expiration of the first cache item via a lock and lookup operation; and
evicting the first cache item from the slab.

2. The method of claim 1, wherein the expiry time is based on at least one of a historical access of the first cache item, a time to live (TTL) associated with the first cache item, or a machine learning model trained on access times of other cache items.

3. The method of claim 1, wherein the eviction review further comprises:
determining an initial expiry time associated with a second cache item and a time to access, wherein the determining occurs without performing a lock and lookup.

4. The method of claim 3, further comprising:
when the expiry time associated with the second cache item is greater than the time to access, updating the expiry time associated with the second cache item to the time to access; and
when a sum of a current time and the time to access is less than the initial expiry time, updating the expiry time associated with the second cache item to the sum of the current time and the time to access.

5. The method of claim 1, wherein the expiry time comprises a Time to Live (TTL) associated with the first cache item.

6. The method of claim 1, wherein the class size defines a byte size of cache items stored within the slab.

7. The method of claim 1, wherein the first cache item is associated with a Time to Access (TTA).

8. A system for cache eviction enforcement, comprising:
a device comprising one or more processors; and
at least one memory storing instructions, that when executed by the one or more processors, cause the device to:
access a slab of a multi-tenant caching system, wherein the slab is defined by a memory size and a class size, the class size corresponding to a size of cache items stored within the slab;
perform an eviction review by sequentially reaping through the slab, based on the class size;
flag a first cache item by the eviction review based on a header of the first cache item, wherein the header comprises a prefix indicative of an expiry time;
confirm expiration of the first cache item via a lock and lookup operation; and
evict the first cache item from the slab.

9. The system of claim 8, wherein the lock and lookup operation comprises:
locking the slab;
identifying a location of the first cache item by performing a lookup using a hash table and a key; and
determining an expiration status of the first cache item.

10. The system of claim 8, wherein the instructions to evict the first cache item from the slab occurs when the eviction review determines that the expiry time is less than a current time.

11. The system of claim 8, wherein the expiry time is based on at least one of historical access of the first cache item, a time to live (TTL) associated with the first cache item, or a machine learning model trained on access times of other cache items.

12. The system of claim 8, wherein when the one or more processors further execute the instructions, the device is configured to:
update the expiry time to a time to access when an initial expiry time is greater than the time to access.

13. The system of claim 8, wherein when the one or more processors further execute the instructions, the device is configured to:
update the expiry time to a sum of a current time and a time to access time, when the sum of the current time and the time to access is less than the expiry time.

14. A computer program product comprising a non-transitory computer readable storage medium having instructions encoded thereon which, when executed, cause a computing system to:
access a slab of a multi-tenant caching system, wherein the slab is defined by a memory size and a class size, the class size corresponding to a size of cache items stored within the slab;
perform an eviction review by sequentially reaping through the slab, based on the class size;
flag a first cache item by the eviction review based on a header of the first cache item, wherein the header comprises a prefix indicative of an expiry time;
confirm expiration of the first cache item via a lock and lookup operation; and
evict the first cache item from the slab.

15. The computer program product of claim 14, wherein the expiry time is based on at least one of historical access of the first cache item, a time to live (TTL) associated with the first cache item, or a machine learning model trained on access times of other cache items.

16. The computer program product of claim 14, wherein flagging the first cache item occurs when the expiry time has been exceeded.

17. The computer program product of claim 14, wherein the eviction review iterates through headers associated with the cache items stored within the slab.
